(19) United States
(12) Patent Application Publication
(10) Pub. No.: US 2008/0123359 A1
(43) Pub. Date: May 29, 2008

(54) Illuminated display system for a vehicle

(76) Inventor: Frederik-Andre Larochelle, Blainville (CA)

Correspondence Address: Franz BONSANG, Patent Agent;c/o EQUINOX PROTECTION, 410 - 1500, Du College, St-Laurent, QC, H4L 5G6, omitted

(21) Appl. No.: 11/603,822

(22) Filed: Nov. 24, 2006

(51) Int. Cl. B60Q 1/00

(52) U.S. Cl. 362/501

(57) ABSTRACT

An illuminated display system for a vehicle provides a display area for a display on a vehicle and an illumination housing which provides illumination, using light emitting diodes (LEDs), of the display in the display area. The LEDs are disposed in an illumination container disposed within the illumination housing and are connected to an actuator for a light in the vehicle. A circuit connecting the LEDs has a resistor disposed thereon, the resistance of the resistor being determined by the colour of the illumination provided by the LED.

### FIELD OF THE INVENTION

The present invention relates to illuminated display systems, and is more particularly concerned with an illuminated display system for illuminating a display on a vehicle.

### BACKGROUND OF THE INVENTION

It is well known in the art to use to appose displays having messages, such as advertising, publicity, or the like, on motorized vehicles. Such displays typically include combinations of letters and images and are typically affixed by painting or by attaching materials, such as vinyl, depicting the message to the exterior of a vehicle, typically a side thereof or the rear thereof. Thus, the display can be seen on the vehicle by persons in proximity to the vehicle.

In order to increase visibility of the display, especially when there is minimal exterior light, illumination systems are often deployed to illuminate, i.e. light, the display and the message thereof. Such illumination systems on vehicles are also well known in the art. For example, U.S. Pat. No. 5,974,711, issued to James Tipke on Nov. 2, 1999 teaches a vehicle-mounted advertising sign which attaches to a side of a vehicle and has a display area illuminated by lights situated behind the surface of the display area. Unfortunately, the display for the system taught by Tipke is mounted on a side window of the vehicle, thus potentially reducing visibility for drivers and passengers. Further, the display disclosed by Tipke protrudes radially outwardly, and substantially perpendicularly, from the side of the vehicle or thereabove. This configuration is not aerodynamic and causes drag on the movement of the vehicle, which may reduce energy efficiency of the vehicle.

U.S. Pat. No. 6,702,351, issued to Buring et al. on Mar. 9, 2004, teaches an illuminated display system for a display on a vehicle in which multiple displays may be shown on the vehicle. Specifically, a display is depicted on each side of triangular display elements in a multi-display box, with the display shown changing as the side visible to observers changes. A lighting fixture which may protrude outwardly from a side of the vehicle illuminates the display. Unfortunately, such an illuminated display system requires co-ordination and alignment of the lights and all of the display elements, which can be complex. Further, complex mounting mechanisms are often required for the display elements. Finally, a large number of components are required for the system taught by Buring, which may be expensive.

Accordingly, there is a need for an improved illuminated display system for a vehicle.

### SUMMARY OF THE INVENTION

It is therefore a general object of the present invention to provide an improved illuminated display system for a vehicle.

An advantage of the present invention is that the illuminated display system uses little electricity compared to existing systems.

Another advantage of the present invention is that the illuminated display system is of simple configuration.

A further advantage of the present invention is that the illuminated display system generally matches the contour of the external surface of the vehicle to which it is attached and is, therefore, aerodynamic.

Still another advantage of the present invention is that the lights for the illuminated display system may be easily replaced.

Another advantage of the present invention is that the illuminated display system is easily activated using pre-existing actuators for lights in the vehicle.

Yet another advantage of the present invention is that the illuminated display system is comprised of resilient materials and is resistant to shocks, reducing the risk of breakage thereof.

A further advantage of the present invention is that the source of the illumination provided thereby is not readily visible to drivers of other vehicles or persons proximal to the vehicle on which the system is deployed, thereby reducing risk that their vision be inhibited.

According to a first aspect of the present invention, there is provided an illuminated display system for a vehicle, the system comprising:
a frame connected to an exterior body of the vehicle and defining a display area disposed thereupon upon which a display may be inscribed, the frame surrounding the display area on an outer edge thereof, the frame having at least one illumination housing extending along at least a portion thereof on the outer edge, the illumination housing having an illumination surface facing towards the display area and configured for extending outwardly away from the display area at a pre-determined projection angle;
for each illumination housing, at least one container cavity extending inwardly from the illumination surface into the illumination housing, the container cavity being configured for receiving an illumination container at a substantially rectilinear angle relative the illumination surface, the illumination container having at least one replaceable light emitting diode (LED) removably disposed therein, the LED providing light for lighting the display area, and thereby the display, and which is projected theretowards at the projection angle.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a side/front view of an illuminated display system for a vehicle, in accordance with an embodiment of the present invention, installed on the exterior of a body of the vehicle;

FIG. 2 is a sectional view of the illuminated display system shown in FIG. 1, showing a cross section of an illumination housing thereof, without the side of the frame for clarity purposes;

FIG. 2a is a view similar to FIG. 2, showing an illumination surface thereof, with the side of the frame;

FIG. 3 is an exploded view of illuminated display system shown in FIG. 1;

FIG. 4 is an enlarged and partially exploded view of the illumination housing shown in FIG. 4, taken along line 4 of FIG. 2, and showing an illumination container removably insertable into the illumination housing;

FIG. 5 is a top view of the illumination housing and illumination container for the illuminated display system shown in FIG. 1;

FIG. 6 is a cross-sectional view of the illumination housing and illumination container shown in FIG. 5, taken along line 6-6 of FIG. 5; and

FIG. 7 is another cross-sectional view of the illumination housing and illumination container shown in FIG. 5, taken along line 7-7, and showing a Light Emitting Diode (LED) extending through an LED socket aperture therefor.

### DETAILED DESCRIPTION OF THE PREFERRED EMBODIMENTS

With reference to the annexed drawings, the preferred embodiments of the present invention will be herein described for indicative purpose and by no means as of limitation.

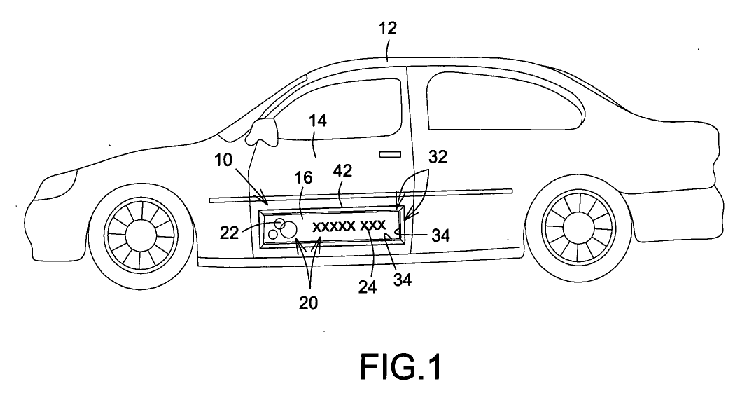

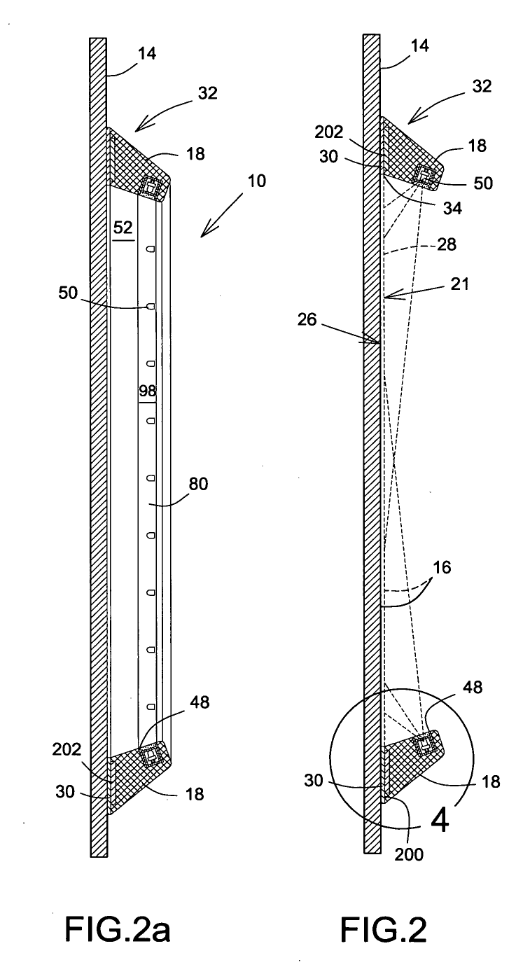

Reference is now made to FIGS. 1 and 2. FIG. 1 is a front view of an illuminated display system, shown generally as 10, for a vehicle 12 in accordance with an embodiment of the present invention. The system 10 is deployed on the exterior body 14 of the vehicle 12, and has a display area 16 disposed on the exterior body 14, in which a message, or display, shown generally as 20, may be inscribed thereupon. The display 20 typically consists of one or more images 22, alphanumeric characters 24, or the like inscribed or affixed to the display area 16. Typically, the display 20, including characters 24 and images 22 therefor, consists of vinyl material from which the display 20 is cut or otherwise fashioned. The vinyl material is affixed to the display area 16, typically with an adhesive such as tape, glue, or the like. Use of a reflective vinyl for the display 20 may be particularly useful, as reflective vinyl will better reflect light and allow for more visible illumination of the display 20. Alternatively, the display 20 could be painted onto the display area 16. In addition, other materials, such as paper, hard plastics, or the like, could be affixed to the display area 16 to form the display 20.

Referring still to FIGS. 1 and 2, the display area 16 may simply be a portion of the exterior body 14 of the vehicle 12. Preferably, and as shown by the dotted lines in FIG. 2, the display area 16 is a sheet 28 of material, and preferably a rubber sheet, affixed to the exterior body 14, possibly in general alignment with the shape and contours thereof, and which abuts a frame, shown generally as 32, surrounding the display area 16. The display 20, is typically inscribed, as described above, on a front display surface 21 of the sheet 16, generally opposite a back display surface 26 thereof which faces the exterior body 14 and which is attached thereto to connect the sheet 28 to the exterior body 14. The sheet 28 is connected impermeably, i.e. in a sealed or otherwise waterproofed manner, to the exterior body 14 using an adhesive such as a glue, double-sided adhesive tape, caulking, or the like. Preferably, however, the sheet 28 is connected to the exterior body 14 by double-sided adhesive tape. It should be noted that other materials than rubber may be used for the display area 16, i.e. the sheet 28, provided the display 20 can be impermeably affixed to the front display surface 21 thereof. Additionally, besides double sided adhesive tape, any adhesive capable of securely attaching the rubber, or other material used for the sheet 28, to the exterior body 14 may be deployed.

Referring now to FIGS. 1, 2, 2a, and 3, the display area 16 is surrounded, and defined by, the frame 32. The frame 32 includes, preferably, at least one connector strip 30 which defines the dimensions and shape of the frame 32. The connector strip 30 is, preferably impermeably, connected to the exterior body 14 and extends around the perimeter of the display area 16 along the outer edge 34 thereof. Specifically, the inside edge of the connector strip 30, and thereby of the frame 32, adjacently surrounds, and thus defines, the outer edges 34 of the display area 16. Preferably, the connector strip 30 is a strip of adhesive double-sided tape, having adhesive on both sides thereof and attached on one side, using the adhesive, to the exterior body 14 to connect the strip 30 thereto. However, it should be noted that, a magnetic strip, not shown, magnetically attachable to the metal of the exterior body 14, could be used as the connector strip 30 instead of adhesive double-sided tape.

Reference is again made to FIGS. 1, 2, 2a, and 3. To provide illumination to the display area 16, the frame 32 also includes at least one illumination housing 18, in which a source of illumination, namely at least one Light Emitting Diode (LED) 50, is situated. The illumination housing 18 extends along at least a portion of the frame 32, preferably adjacently abutting at least a portion of the outer edge 34, and is, preferably impermeably, connected to the connector strip 30. The entire frame 32, preferably, has at least one illumination housing 18 extending therearound. For example, as shown in FIG. 1, where the frame 32 and display area 16 are rectangular in shape, there is an illumination housing 18 on each side of the frame 32. However, if desired, there could be an illumination housing 18 on only one side, or a portion thereof, of the frame 32 shown in FIG. 1. Further, the frame 32 and display area 16 may be of any shape or size and are not limited to the rectangular shape shown in FIG. 1. The illumination housing 18 is preferably made of rubber material, thus providing a degree of flexibility and resiliency thereto, as well as resistance to shocks that may occur during movement of the vehicle 12. Use of the rubber material, which is also water resistant, accordingly reduces the risk of breakage of the housing 18.

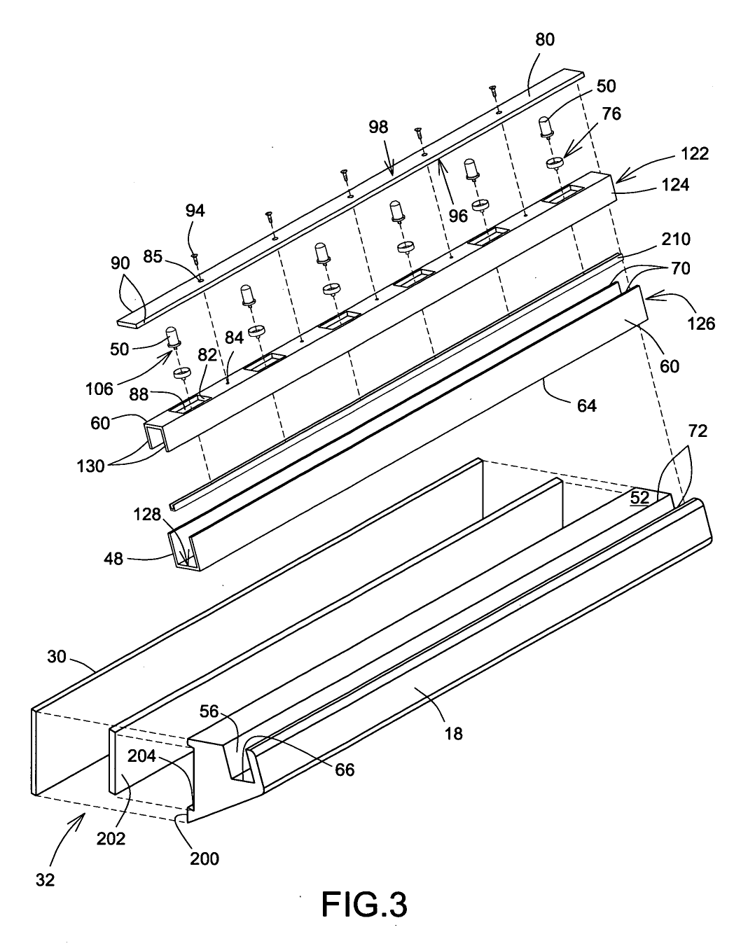

Reference is now made to FIGS. 2, 2a, and 3. The illumination housing 18 has a connecting side 200, i.e. a connecting wall, facing toward the exterior body 14 and of which at least a portion is connected to the connector strip 30. When a strip of double-sided tape is deployed as the connector strip 30, the connecting side 200 is, preferably impermeably, connected thereto by attachment thereto with the adhesive on the side of the double-sided tape opposite the side thereof which is connected to exterior body 14. Where the connector strip 30 is a magnetic strip, the connecting wall 200 may be connected to the connecting wall by use of double-sided tape, glue, or any other adhesive known in the art that is capable of bonding the connector strip 30 and the connecting side 200 together with sufficient strength to hold them together during motion of the vehicle 12. The connecting side 200 and connector strip 30 are configured, for example sized and shaped, such that the connector strip 30 extends at least to all edges of the connecting side 200 when the connecting side 200 is connected thereto. Thus, the connector strip 30 extends between, i.e. covers, the entire length and width of the connecting side 200 when connected thereto. Accordingly, the connecting side 200, and therefore illumination housing 18, do not make direct contact with the exterior body 14 and are connected thereto via the connector strip 30.

As the illumination housing 18 is made of flexible rubber material, a reinforcing member 202 of rigid material is also deployed in system 10 for each illumination housing 18 to provide reinforcement thereof. The reinforcing member 202 is securely disposed within a reinforcing member cavity 204 which extends inwardly into the illumination housing 18 from the connecting side 200 thereof. The reinforcing member 202 is configured, for example sized and shaped, such that the reinforcing member 202 fills the reinforcing member cavity 204 and extends thereacross in alignment with the portions of the connecting side 200 which connect to the connector strip 30. Thus, the reinforcing member 202, or at least a portion thereof, can be, preferably impermeably, connected to the connector strip 30 along with the connecting side 200 when the connecting side 200 is connected to the connector strip 30. The reinforcing member 202 may be connected to the illumination housing 18 in the reinforcing member cavity 204 by double-sided tape, glue, or any other adhesive known in the art that is capable of bonding the reinforcing member 202 and the housing 18 with sufficient strength to hold them together during motion of the vehicle 12. Alternatively, the reinforcing member 202 may be configured such that it is held snugly and securely in place in the reinforcing member cavity 204 once it is placed therein. The reinforcing member 202 may be connected to the connector strip 30 in exactly the same fashion as the connecting side 200. The rigid material of the reinforcing member is preferably a metal or a rigid plastic.

Reference is now made to FIGS. 2, 3, and 4. The illumination housing 18 houses a, preferably removable, illumination container 48 made of impermeable, i.e. waterproof, material. Within the container 48, at least one Light Emitting Diode (LED) 50 disposed in a respective electronic LED socket, shown generally as 76, therefor provides light for illuminating the display area 16 and the display 20 inscribed thereupon. The illumination housing 18 has an illumination surface 52 which is configured, i.e. positioned, to extend outwardly away from the exterior body 14, in proximity to outer edge 34, and connector strip 30 at a projection angle 54 relative the display area 16 when the housing 18 is connected to the connector strip 30. Accordingly, the illumination surface 52 also extends outwardly away from connecting side 200. The illumination container 48 is disposed, preferably removably, in a container cavity 56 and is generally inserted thereinto during assembly of the system 10. The container cavity 56 extends from the illumination surface 52 into the illumination housing 18 at a substantially rectilinear angle 58, i.e. an angle of approximately ninety degrees, relative the illumination surface 52. The container cavity 56 and illumination container 48 are configured, e.g. sized and shaped, such that, when illumination container 48 is disposed within the container cavity 56 with the container bottom 64 of the container 48 adjacent and abutting the container cavity bottom 66 of the container cavity 56, the top of the illumination container 48, and more specifically top ends 70 of container side walls 60 generally opposite container bottom 64, are in generally co-planar alignment with the cavity edges 72 of the container cavity 56 and the illumination surface 52. The illumination container 48 and container cavity 56 are further configured such that, when the container 48 is inserted into the container cavity 56, the container side walls 60 are adjacent and abut the cavity walls 62 of the container cavity 56.

Referring now to FIGS. 5, 6, and 7, the illumination container 48 is formed of inner container portion, shown generally as 122, and outer container portion, shown generally as 126. Inner container portion 122 consists of upper container wall 82 and inner container portion walls 124, which extend radially outwardly, and preferably perpendicularly, away from upper container wall 82. Outer container portion 126 consists of container bottom 64 and container side walls 60, which extend radially outwardly, and preferably perpendicularly, from container inner bottom surface 128 of container bottom 64. Container portions 122, 126 are configured for removable insertion of inner container portion 122 into outer container portion 126 with inner container portion walls 124 mating in abutting contact with container side walls 60 and, preferably, with inner container wall ends 130 of inner container portion walls 124, situated generally opposite upper container wall 82, in abutting contact with the inner bottom surface 128. Additionally, container portions 122, 126 are configured such that, when inner container portion 122 is inserted into outer container portion 126 as described, upper container wall 82 is recessed from container side wall top ends 70 and defines cover recess 132 therewith. It should be noted that, optionally, inner container portion 122 may be fixedly and impermeably attached to outer container portion 126, using an adhesive such as glue, caulking, or the like applied to the walls 60, 124 or to the inner container wall ends 130 of inner container portion walls 124 and the container bottom surface 128.

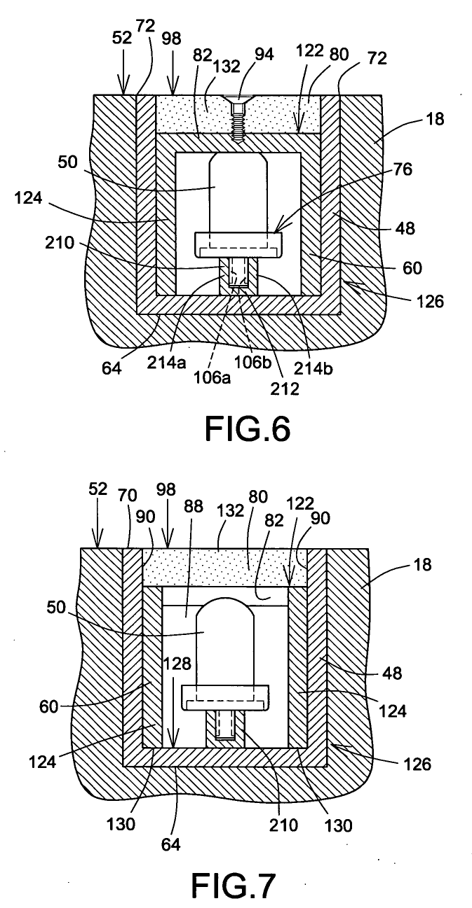

Referring to FIGS. 6 and 7, container cover 80 is removably inserted into illumination container 48, specifically into cover recess 132 and impermeably covers the container top, shown generally as 68. More specifically, the container cover 80 and container 48 are configured such that, when the container cover 80 is connected to container 48, cover 80 rests in cover recess 132 with cover edges 90 mating, preferably impermeably, with container side walls 60. At the same time, the bottom cover surface 96 of the cover 80 extends over upper container wall 82 in contact therewith. Further, the top cover surface 98 of the container cover 80, generally opposite the bottom cover surface 96, extends between top ends 70 of illumination container 48 in substantially co-planar alignment with the top ends 70 thereof. Accordingly, when the illumination container 48 is disposed in illumination housing 18, the top cover surface 98 is in generally smooth and substantially co-planar alignment with the cavity edges 72 and the rest of the illumination surface 52, a portion of which is formed by the top cover surface 98.

Reference is again made to FIGS. 5, 6 and 7. The container cover 80 is constructed of impermeable, i.e. waterproof, material and is removably impermeably connected, by attachment means, to the upper container wall 82. The upper container wall 82 also has LED socket apertures 88 situated therein, generally aligned in register with the electrical LED sockets 76. The container cover 80, i.e. the material thereof, is preferably transparent and frosted or glazed. Thus, the light generated by LEDs 50 may pass transparently through the container cover 82 to illuminate display area 16 while, at the same time, the frosted or glazed character of the container cover 82 diffuses the light to help increase the amount of the display area 16 covered thereby. The impermeable, i.e. waterproof, material from which the container cover 80 and illumination container 48 are made is preferably a lightweight and durable plastic. However, other impermeable and durable materials may also be used, provided they are impermeable, i.e. waterproof, and can support the stress placed upon the illumination container 48 and the container cover 80 when deployed in illumination housing 18 on the vehicle 12.

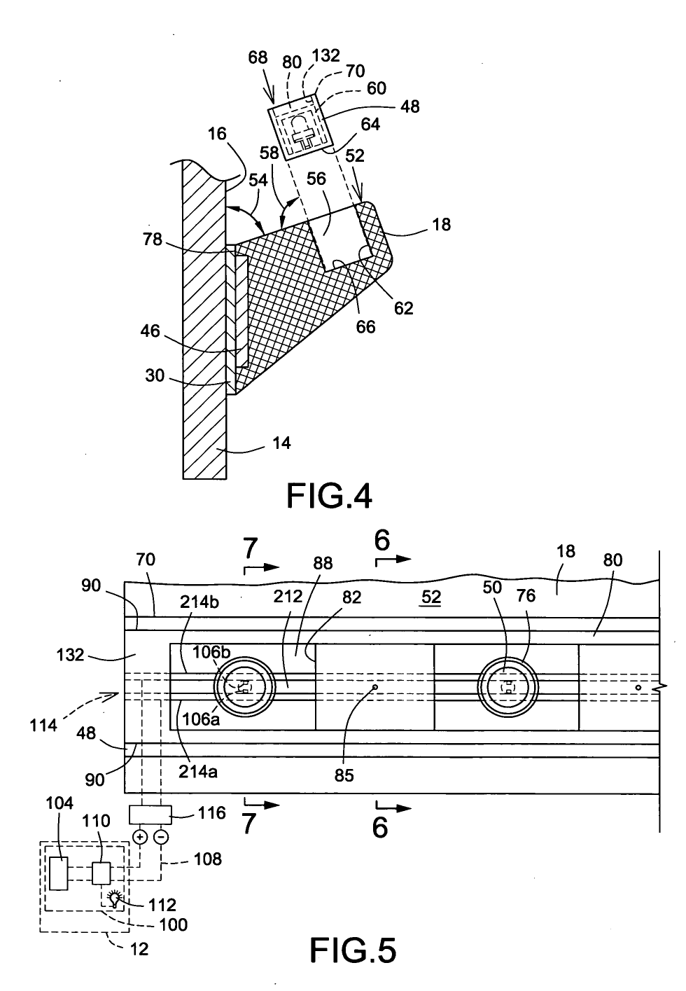

Reference is now made to FIGS. 3, 5, and 6. The attachment means consists of container screws 94, threaded screw sockets 84 in upper container wall 82, and screw apertures 85 in the container cover 80. More specifically, the upper container wall 82 has at least one, and preferably more than one, threaded screw socket 84 disposed therein. The container cover 80 has, for each threaded screw socket 86 a respective screw aperture 85. The screw sockets 86 and screw apertures 85 are configured, i.e. positioned, such that each screw aperture 85 is aligned in registration with the respective screw sockets 84 when the container cover 80 is placed in the cover recess 132 with cover edges 90 mated with the container side wall 60 to cover container top 68. The container screws 94 are then inserted through the screw apertures 85 and engaged, i.e. screwed, into the screw sockets 86 to removably and impermeably connect the cover 80 to the illumination container 48. Conversely, the container cover 80 can be removed by disengaging, i.e. unscrewing, the container screws 94 from the screw sockets 86 and then removing the container cover 80. When the container cover 80 is removed, a user may access LEDs 50 in LED sockets 76 via LED socket apertures 88 to install or remove both LEDs 50 and LED sockets 76. It should be noted that the attachment means could also consist of clamps or clasps for holding the container cover 80, removable adhesive tapes, other adhesives, or any other attachment means by which the container cover 80 can be impermeably and removably connected to the illumination container 48 with the cover edges 90 mating with the container side walls 60 as described above. Reference is now made to FIGS. 1 and 4. As the illumination container is inserted at a rectilinear angle 58 relative the illumination surface 52 and the container top cover surface 98 is in substantially co-planar alignment with the illumination surface 52, the light generated by LEDs 50 passes through container cover 80 and is projected onto the display area 16 and the display 20, to provide illumination thereof, at, approximately, the projection angle 54. In other words, the projection angle 54 is the approximate angle, between the display area 16 and the illumination surface 52, at which light generated by the LEDs 50 is projected from illumination housing 18 and surface 52 towards the display area 16 to provide light, i.e. illumination, thereof. The projection angle 54 is typically established, i.e. pre-determined, during manufacture of the system 10, and notably of the illumination housing 18, possibly at the request of a customer for the system 10. It should be noted that since the LEDs 50 are situated in the illumination container 48 within the illumination housing 18, with the illumination surface 52 slanted towards the display area 16 at projection angle 54, the LEDs 50 are typically not directly visible to drivers of other vehicles or to observers situated alongside vehicle. Further, the light projected by the LEDs 50 is projected towards display area 16 and not directly towards other vehicles or observers. Accordingly, there is little risk that light from the LEDs 50 will temporarily obscure the vision of other drivers or observers.

Reference is now made to FIGS. 3, 5 and 7. As mentioned previously, each LED 50 is removably inserted into an electrical LED socket 76, which is, in turn removably inserted into an electrically conductive common rail 210, connected to the electrical system 100 of the vehicle, aligned, i.e. in registration with, the LED socket apertures 88. More specifically, the electrical LED sockets 76 are configured, i.e. sized and shaped for insertion into the electrically conductive common rail 210, either by a twist-lock motion, such as is well known for Christmas lights, or by simply inserting them by therein by exerting a pressure thereupon, which releasably retains the LED sockets 76 therein. The electrically conductive common rail 210 is inserted into the illumination container 48 and has non-conductive bottom portion 212 situated proximal to, and possibly in abutting contact with or connected to, the container bottom surface 128. The rail 210 also has electrically conductive rail side walls 214, made of an electrically conductive material, namely negative (−) rail side wall 214a and positive (+) rail side wall 214b, which constitute the portion of the rail 210 connected to the electrical system 100.

Each LED 50 has, in turn, two LED electrical connectors 106, namely a negative (−) LED electrical connector 106a and a positive (+) LED electrical connector 106b. The LED sockets 76 and LEDs 50 are configured for insertion of the LEDs 50 into the LED sockets 76, possibly through the LED socket apertures 88, by twisting or screwing the LEDs 50 into the LED sockets 76, similar to a “twist lock” configuration commonly used for Christmas lights, until the LED electrical connectors 106a, 106b respectively contact the rail side walls 214a, 214b. Similarly, the LEDs 50 can be removed, when the container cover 80 is removed, by unscrewing the LEDs 50 and pulling them out of the LED sockets 76. Thus, the LEDs 50 can easily be installed and replaced. Alternatively, the LEDs 50 and LED sockets 76 can be configured such that LEDs 50 can be inserted into LED sockets 76 by aligning LED electrical connectors 106a, 106b for contact respectively with the rail side walls 214a, 214b and exerting a pressure on the LEDs 50, directed towards the LED sockets 76, to push LEDs 50 thereinto. In this configuration, the LEDs 50 can be removed from the LED sockets 76 by exerting a pressure directed away from the LED sockets 76 to pull the LEDs 50 out of the LED sockets 76. It should be noted that the illumination container 48 may have many rows of LED sockets 76 with LEDs 50 therein. The number of such rows, and the quantity of LED sockets 76 for each row, will generally be determined when the system 10, and in particular the illumination container 48, is manufactured, based on the size of the display area 16, the display 20 itself, and the intensity of illumination required.

Once LED electrical connectors 106a, 106b of an LED 50 are in contact with, respectively, rail side walls 214a, 214b and rail side walls 214a, 214b are connected to the electrical system 100, electrical current from electrical system 100 flows through rail side walls 214a, 214b and into LED 50 through LED electrical connectors 106a, 106b for illuminating the LED 50. More specifically, and as best shown in FIG. 5, the respective LED electrical connectors 106 for the LEDs 50 are connected in parallel by rail side walls 214 to a, preferably pre-existing, actuator 110 in the electrical system 100 of the vehicle 12. The actuator 110 is connected to a pre-existing vehicle light 112, preferably the headlights of the vehicle 12, present on vehicle 12 prior to installation of the system 10. Thus, when the LEDs 50 are installed in LED sockets 76, themselves installed in the common conductive rail 210, the LEDs 50, LED electrical connectors 106, and the rail side walls 214 of the rail 210 form a parallel circuit, shown generally as 114, by which each LED 50 is connected, in parallel electrical connection, to the electrical system 100 and actuator 110. Thus, a user may actuate and deactuate illumination of the system 10, i.e. the LEDs 50, to, respectively, illuminate and cease illumination of the display area 16 by, respectively, using the actuator 110 to respectively actuate and deactuate the vehicle light 112. The power source for the LEDs 50 is the same as that for the electrical system 100, typically the battery 104 of the vehicle 12. Advantageously, the parallel connection of the LEDs 50 allows the LEDs 50 to continue to receive electrical power via the circuit 114 from the electrical system 100 and battery 104, and thus continue functioning, even when one of the LEDs 50 ceases to function, for example when one of the LEDs 50 is burnt out.

The LEDs 50 can provide light in a variety of colours. More specifically, a given LED 50 is generally manufactured so as to provide light in a specific colour and therefore, for each colour, there is a specific type of LED 50 associated therewith. For an LED 50 emitting a specific colour, i.e. a specific colour type of LED 50 for the colour, there is corresponding current range of electrical current for which the LED 50 is designed to have pass therethrough. However, the amount of current provided from the electrical system 100 is usually constant, typically 12 volts from the battery 104, and may not conform to this range. Accordingly, a resistor 116, situated on the electrical circuit 114 connecting the LED 50 to the electrical system 100, is deployed to regulate the current provided to the LED 50 to an acceptable level, i.e. below the maximum amount. If desired, there can be a single resistor 116 for all of the LED's 50, for cases in which all of the LED's 50 emit the same colour of light. Alternatively, when it is necessary that the LEDs 50 emit different colours of light, thus requiring different corresponding colour types of LEDs 50, a plurality of resistors 116 may be required. Specifically, each LED 50 of a given colour type will have to be connected to respective resistor 116 for that colour type residing on the electrical circuit 114 that regulates the electrical current passing through the LEDs 50 to the respective current range therefore. By using different resistors 116 and levels of resistance, at least fifteen (15) different colours of light may be emitted by the LED's 50. The resistors 116 are typically installed during manufacture of the illumination container 48, preferably based on a choice in colour made by the user. Advantageously, each LED 50 uses less than one waft (1 W) of energy, and thus the system 10 is highly energy efficient. Further, the LED's 50 have a long life expectancy, i.e. up to 100 000 hours of use, and are difficult to break, thus contributing to longevity of the system 10 and reducing maintenance requirements for replacing light bulbs, as compared to systems using more traditional illumination materials, such as incandescent light bulbs. LEDs 50 are also available in a variety of shapes, sizes, and textures.

In general, the illumination container 48, housing 18, display area 16, and frame 32 may be manufactured at the same time, based on pre-determined standards or on customer specifications. The frame 32 may then be painted and the LED's 50 and resistors 116 installed, based on the user's specifications. The illumination housing 18, frame 32 and display area 16 are then installed on the exterior body 14 of the vehicle 12 and the illumination housing 18 and the LED's 50 connected to the electrical system 100 to complete installation of system 10 on the vehicle 12.

While a specific embodiment has been described, those skilled in the art will recognize many alterations that could be made within the spirit of the invention, which is defined solely according to the following claims.

I claim:

1. An illuminated display system for a vehicle, said system comprising:
a frame connected to an exterior body of the vehicle and defining a display area disposed thereupon upon which a display may be inscribed, said frame surrounding said display area on an outer edge thereof, said frame having at least one illumination housing extending along at least a portion thereof on said outer edge, said illumination housing having an illumination surface facing towards said display area and configured for extending outwardly away from said display area at a pre-determined projection angle;
for each illumination housing, at least one container cavity extending inwardly from said illumination surface into said illumination housing, said container cavity being adapted for receiving an illumination container at a substantially rectilinear angle relative said illumination surface, said illumination container having at least one replaceable light emitting diode (LED) removably disposed therein, said LED providing light for lighting said display area, and thereby said display, and which is projected theretowards at said projection angle.

2. The illuminated display system of claim 1, wherein said display area is rectangular in shape, said illumination housing extending along a side of said rectangular shape alongside said outer edge.

3. The vehicle illuminated display system of claim 1, wherein said frame is comprised of at least one connector strip connecting said exterior body and said illumination housing, said connector strip comprising one of a strip of double-sided adhesive tape and a magnetic strip.

4. The illuminated display system of claim 1, wherein said display area is a surface of a sheet disposed on said exterior body and abutting said frame.

5. The illuminated display system of claim 4, wherein said sheet is comprised of a rubber material.

6. The illuminated display system of claim 1, wherein said display area is comprised of a portion of said exterior body.

7. The illuminated display system of claim 1, wherein said display comprises at least one piece of vinyl material, said piece of vinyl being attachable to said display area to inscribe said display thereupon.

8. The illuminated display system of claim 7, wherein said vinyl material is a reflective vinyl material.

9. The illuminated display system of claim 1, wherein said LED is connected to an electrical system of said vehicle for providing electrical current to said vehicle, said electrical system further providing said electrical current to said LED for lighting said LED.

10. The illuminated display system of claim 9, wherein said LED is further connected to an electrical switch in said electrical system for selectively enabling and disabling flow of said electrical current from said electrical system to said LED for respectively actuating and deactuating said LED.

11. The illuminated display system of claim 9, wherein said LED is connected by a parallel circuit to said electrical system.

12. The illuminated display system of claim 10, wherein said LED is of a pre-determined colour type configured to emit a pre-determined colour of light, said system further comprising an electrical resistor connected to said LED and to said electrical system, said electrical resistor providing an electrical resistance for regulating said electrical current to a pre-determined range for said LED based on said pre-determined colour type.

13. The illuminated display system of claim 9, further comprising a respective LED electrical socket for each LED, said LED being removably insertable thereinto, and an electrically conductive common rail connected to said electrical system and disposed in said illumination container, each LED electrical socket being removably inserted into said common rail and thereby electrically connected to said electrical system.

14. The illuminated display system of claim 1, further comprising a removable container cover, said removable container cover extending over and impermeably covering a top of said illumination housing when attached thereto, said top being open when thereto said container cover is removed.

15. The illuminated display system of claim 13, further comprising a removable container cover and wherein said illumination container comprises an upper container wall having for each LED electrical socket, an LED socket aperture extending therethrough configured for removable insertion therethrough of said LED into said LED electrical socket, said removable container cover impermeably covering said upper container wall when removably attached to said upper container wall with an attachment means.

16. The illuminated display system of claim 14, wherein said container cover is frosted and transparent.

17. The illuminated display system of claim 14, wherein said container cover is comprised of plastic.

18. The illuminated display system of claim 15, wherein said lighting container is comprised of:
an outer container portion having a container inner bottom surface extending between two container side walls thereof, said electrical sockets being disposed on said bottom inner bottom surface; and
an inner container portion having said upper container wall with said LED socket aperture and having a set of inner container portion walls extending away from said upper container wall, said inner container portion being disposed within said outer container portion with said inner container portion walls in abutting contact with said container side walls and said container inner bottom surface and said each LED socket aperture in register with said respective LED electrical sockets therefor to form said illumination container.

19. The illuminated display system of claim 1, wherein said illumination housing is comprised of a rubber moulding and has a connecting wall, at least a portion of said connecting wall being connectable to said connector strip to connect said illumination housing thereto.

20. The illuminated display system of claim 19, said illumination housing further comprising a reinforcing member of rigid material and disposed within a reinforcing member cavity extending into said housing from said connecting wall, said reinforcing member being adapted for extending across said reinforcing member cavity and for connection of at least a portion thereof to said connector strip when said connecting wall is connected thereto.
